(19) United States
(12) Patent Application Publication
(10) Pub. No.: US 2015/0034632 A1
(43) Pub. Date: Feb. 5, 2015

(54) DEVICE FOR APPLYING RF ENERGY TO A CAVITY

(71) Applicant: GOJI LTD., Hamilton (BM)

(72) Inventors: Yishai Brill, Beer Shova (IL); Eliezer Gelbart, Holon (IL)

(21) Appl. No.: 14/377,942

(22) PCT Filed: Feb. 13, 2013
(86) PCT No.: PCT/IB2013/000635

§ 371 Date: Aug. 11, 2014

Related U.S. Application Data
(60) Provisional application No. 61/598,489, filed on Feb. 14, 2012.

(51) Int. Cl. H05B 6/70; H05B 6/72

(52) U.S. Cl. CPC H05B 6/707; H05B 6/72
USPC 219/697; 29/601

(57) ABSTRACT

An apparatus for applying RF energy to an object in a cavity is disclosed. The apparatus may include a plurality of pairs of radiating ports, and a plurality of electrically conductive elements. Each pair of radiating ports may include two radiating ports configured to emit RF radiation into the cavity coherently with each other; and each electrically conductive element may be positioned between two radiating ports constituting a pair of radiating ports. The electrically conductive elements may be arranged such that RF radiation emitted by the plurality of pairs of radiating ports concentrates closer to the center of the cavity than that in the absence of the electrically conductive elements.

This application claims the benefit of priority to U.S. Provisional Patent Application No. 61/598,489, filed on Feb. 14, 2012, which is incorporated herein in its entirety.

### TECHNICAL FIELD

This patent application relates to an apparatus for applying electromagnetic energy and more particularly but not exclusively to applying radio frequency (RF) energy to an energy application zone via a waveguide feeding structure for processing an object.

### BACKGROUND

Electromagnetic waves have been used in various applications to supply energy to objects. In the case of RF radiation for example, RF energy may be supplied using a magnetron, which is typically tuned to a single frequency for supplying RF energy only at that frequency. One example of a commonly used device for supplying electromagnetic energy is a microwave oven. Typical microwave ovens supply electromagnetic energy at or about a single frequency of 2.45 GHz.

### Summary of a Few Exemplary Aspects of the Disclosure

Some exemplary aspects of the disclosure include apparatuses for applying electromagnetic energy to an object in an energy application zone. More particularly, some exemplary apparatuses may be configured to apply RF energy via a waveguide feeding structure comprising one or more elements configured to electrically divide an aperture of the waveguide feeding structure into two or more sections. The divided sections may each constitute a separate waveguide feeding structure. Each of the divided sections may be configured to support at least one propagating wave mode, i.e., the dimensions of each section may be substantially proportional to the wavelength of the waves emitted and propagating in each section. —For example, the length of the section may be a multiple of half—the wavelength of the emitted wave. The proportionality may be the same across the different sections. The term “substantially” (such as in “substantially proportional”, “substantially equal”, and the like) is used herein to indicate a deviation of no more than about 10%.

Some exemplary aspects of the invention may be directed to an apparatus for applying RF energy comprising a waveguide feeding structure that includes an aperture. The apparatus may further include at least one radiating element configured to emit RF energy within the waveguide feeding structure. The apparatus may also include one or more electrically conductive elements located within the waveguide feeding structure and configured to electrically divide the aperture into two or more sections.

In some embodiments, the apparatus may include a rectangular cavity, having an opening for a door; a back wall facing the opening; a top wall; a bottom wall; and first and second opposing sidewalls. The distance between the opening for the door and the back wall may be referred to as a width. In some embodiments, the width is larger than the wavelength of the electromagnetic radiation corresponding to the lowest frequency applied for processing. The apparatus may further include a first conductive element electrically connecting the top wall and the bottom wall of the cavity adjacent to the first opposing sidewall. Consistent with this disclosure, adjacent or in proximity to a wall may mean closer to the wall than to the center of the energy application zone. A conductive element in proximity to a wall may be closer to the wall than to the center by a factor of, for example, 2, 5, 10, or any intermediate or larger factors. The apparatus may further include a second conductive element electrically connecting the top surface and the bottom surface of the cavity adjacent to the second opposing sidewall. In some embodiments, the apparatus may include a first radiating element having two ports at substantially equal distances from a center of the first conductive element, and a second radiating element having two ports at substantially equal distances from a center of the second conductive element.

This summary refers to only some exemplary aspects of the disclosed embodiments. For a more detailed description of additional exemplary aspects of the invention, reference should be made to the drawings, detailed description, and claims.

### BRIEF DESCRIPTION OF THE DRAWINGS

FIGS. 1A and 1B include diagrammatic representations of top and side views of an apparatus having one pair of waveguide feeding structures for applying electromagnetic energy to an object, in accordance with some exemplary embodiments of the present invention;

FIG. 1C includes a diagrammatic representation of a radiating element, in accordance with some exemplary embodiments of FIGS. 1A and 1B;

FIGS. 1D and 1E include diagrammatic representations of top and side views of an apparatus having two pairs of waveguide feeding structures for applying electromagnetic energy to an object, in accordance with some exemplary embodiments of the present invention;

FIG. 1F includes a diagrammatic representation of a top view of an apparatus, according to some embodiments of the invention;

FIGS. 2A and 2B include diagrammatic representations of top and side views of another apparatus for applying electromagnetic energy to an object, in accordance with some exemplary embodiments of the present invention;

FIGS. 3A and 3B include diagrammatic representations of top and side views of yet another apparatus for applying electromagnetic energy to an object, in accordance with some exemplary embodiments of the present invention;

FIGS. 4A and 4B illustrate top and side views of yet another apparatus for applying electromagnetic energy to an object, in accordance with some exemplary embodiments of the present invention;

FIG. 4C include a diagrammatic representation of a radiating element, in accordance with some exemplary embodiments of FIGS. 4A and 4B;

FIG. 5A includes a diagrammatic representation of an apparatus for applying RF energy to an object located in an energy application zone, in accordance with some embodiments of the invention;

FIG. 5B includes a diagrammatic representation of a system for applying RF energy to an object located in an energy application zone, in accordance with some embodiments of the present invention;

FIG. 6 includes a flowchart of a method for making an apparatus for applying RF energy, in accordance with some exemplary embodiments of the present invention;

FIGS. 7A-7D illustrate exemplary apparatuses for applying RF energy to process an object, in accordance with some exemplary embodiments of the present invention;

FIGS. 8A and 8B include simulation results, presented as intensity maps, for heating nine water cups using an apparatus for applying electromagnetic energy, in accordance with some embodiments of the present invention; and

FIG. 9 is a diagrammatic representation of an apparatus for applying RF energy to an object in a cavity, according to some embodiments of the present invention.

### DETAILED DESCRIPTION

Reference will now be made in detail to exemplary embodiments of the invention, examples of which are illustrated in the accompanying drawings. When appropriate, the same reference numbers are used throughout the drawings to refer to the same or like parts.

In some aspects, the invention may be directed to an apparatus for applying electromagnetic energy. The term electromagnetic energy, as used herein, includes energy deliverable by electromagnetic radiation in all or portions of the electromagnetic spectrum, including but not limited to, radio frequency (RF), infrared (IR), near infrared, visible light, ultraviolet, etc. In one particular example, applied electromagnetic energy may include RF energy deliverable by electromagnetic radiation with a wavelength in free space of 100 km to 1 mm, which corresponds to a frequency of 3 KHz to 300 GHz, respectively. In some other examples, the applied electromagnetic energy may fall within frequency bands between 500 MHz to 1500 MHz or between 700 MHz to 1200 MHz or between 800 MHz-1 GHz. Applying energy in the RF range of the electromagnetic spectrum is referred herein as applying RF energy. Microwave and ultra-high frequency (UHF) energy, for example, are both within the RF range. In some other examples, the applied electromagnetic energy may fall only within one or more industrial, scientific, and medical (ISM) frequency bands, for example, between 433.05 and 434.79 MHz, between 902 and 928 MHz, between 2400 and 2500 MHz, and/or between 5725 and 5875 MHz. Even though examples of the invention are described herein in connection with the application of RF energy, these descriptions are provided to illustrate exemplary principles of the invention and are not intended to limit the invention to any particular range of the electromagnetic spectrum.

Some embodiments of the invention may include at least one waveguide feeding structure configured to apply RF energy to an energy application zone. In some aspects, the energy application zone may be located (partially or wholly) within a waveguide and may be referred to as waveguide-type energy application zone. The waveguide may be fed by the waveguide feeding structure. A waveguide feeding structure may be defined as any apparatus having a structure configured to feed propagating RF waves (e.g., traveling waves) to a waveguide or otherwise support propagating RF waves in a waveguide. One or more waveguide feeding structures may be provided to feed a single waveguide. The propagating RF waves may be emitted by a radiating element located in, partially located in, or otherwise associated with the waveguide feeding structure. The energy application zone may include any void, location, region, or area where electromagnetic energy may be applied. It may be hollow, or may be filled or partially filled with liquids, solids, gases, or combinations thereof.

The waveguide feeding structure may include an aperture through which the RF waves may be emitted or propagate to the waveguide. In some embodiments, the dimension of the aperture may support at least one propagating mode, so that the RF waves may propagate in at least a portion of the waveguide and/or the energy application zone. For example, the RF waves may propagate in an object to be processed that is placed in the energy application zone. In some embodiments, the RF waves propagating in a particular portion of the energy application zone may apply RF energy to that portion in an amount sufficient to process the object or a portion thereof. The waveguide feeding structure may be constructed such that the ratio between the width and the height of the waveguide feeding structure aperture may be larger than 2:1, optionally 4:1. Waves emitted from a radiating element in the waveguide feeding structure may propagate from the waveguide feeding structure to the energy application zone such that a portion of the RF waves may travel through the object resulting in processing of the object. When the waves travel through less than the entire object, energy application may provide non-uniform heating of the object.

In certain embodiments, RF energy may be applied to process an object and/or to receive feedback indicative of the response to RF radiation received from the object in the cavity (e.g., to sense one or more properties of the object, such as phase change, chemical composition, doneness level, etc.). It is contemplated that an object is considered “in” the energy application zone if at least a portion of the object is located in the zone or if some portion of the object receives delivered electromagnetic radiation. References to an “object” (or “object to be heated” or “object to be processed”) to which RF energy is applied are not limited to a particular form. An object may include a liquid, semi-liquid, solid, semi-solid, or gas, depending upon the particular process with which the invention is utilized. The object may also include composites or mixtures of matter in differing phases.

By way of non-limiting examples, the term “object to be processed” may encompass such matter as food to be defrosted or cooked; clothes or other wet material to be dried; frozen organs to be thawed; chemicals to be reacted; fuel or other combustible material to be combusted; hydrated material to be dehydrated, gases to be expanded; liquids to be heated, boiled or vaporized, or any other material for which there is a desire to apply, even nominally, electromagnetic energy.

Consistent with embodiments of this disclosure, an object may be considered “processed” by RF energy if at least one property of at least a portion of the object changes in response to the RF energy application. For example, a portion of a frozen object may be thawed, the temperature of a portion of the object may rise, the texture of at least a portion of the object may change, a chemical reaction may occur at a portion of the object, or the taste of a portion of a food item may change, etc.

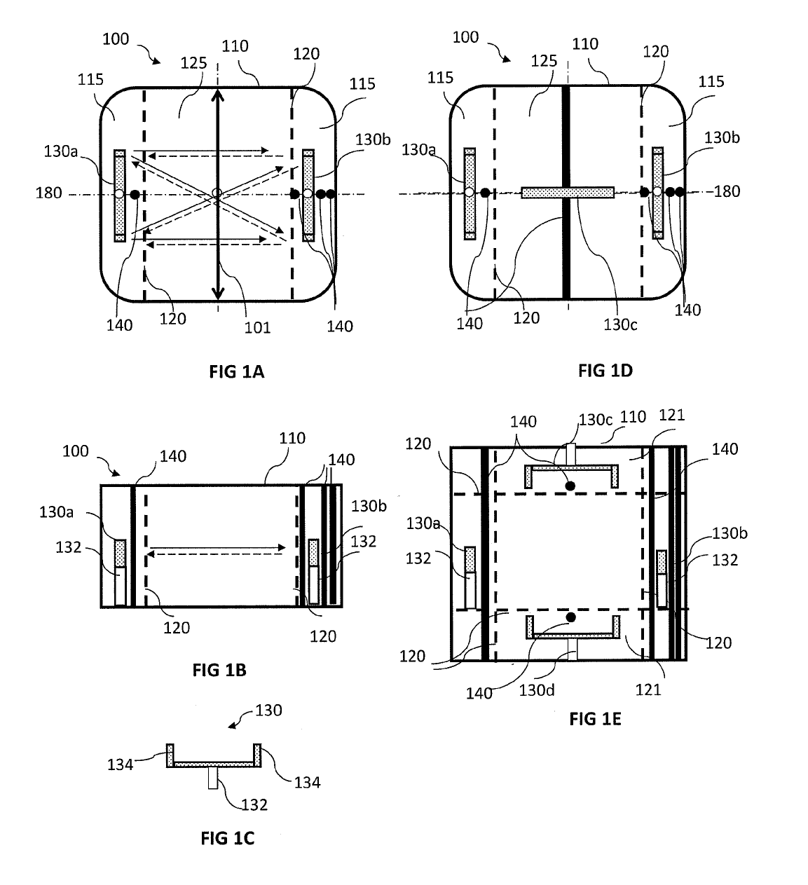

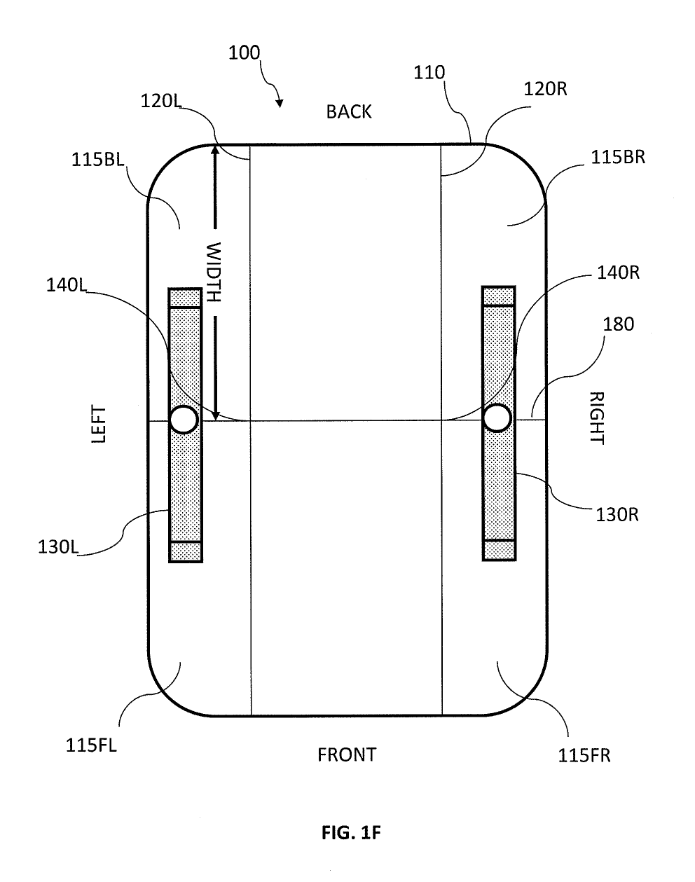

RF radiation may be applied to the energy application zone by at least one radiating element provided in the waveguide feeding structure. The energy application zone may be of a waveguide type, and thus may support propagation of the RF radiation, for example, from one radiating element to another across the energy application zone or across a portion thereof. The energy application zone, in which the object to be processed is placed, may be located within the waveguide, partially or entirely. A radiating element may be any element, system, array of elements, etc. designed or configured to transmit, radiate or emit RF radiation. In some embodiments, one or more radiating element(s) may be further configured to receive RF energy from the energy application zone. At times, the same radiating element may be configured to both emit RF energy to a zone and receive RF energy from the zone, during different time periods, the same time periods, or overlapping time periods. The radiating element may include an antenna, an array of antennas, an array of radiating ports, an RF feed, or an array of feeds. The radiating element may be located within the waveguide feeding structure. In some embodiments, more than one radiating element may be located within the waveguide feeding structure. The radiating element may include one or more ports for emitting RF waves to the energy application zone (e.g., to the waveguide) and/or receiving RF energy from the zone. In exemplary embodiments of the invention, each radiating element may include one, two, three, or more radiating ports (radiating elements with two and three radiating ports are illustrated for example in FIGS. 1C and 4C). A radiating element including two ports may be referred to as a dual-port radiating element.

The orientation and/or configuration (e.g., number of ports) of each radiating element may be distinct or the same, based on the specific energy application, e.g., based on a desired target effect or dimensions of the energy application zone. The radiating elements may be positioned, adjusted, and/or oriented to emit electromagnetic waves along a same direction, or various different directions. Furthermore, the location, orientation, and configuration of each radiating element may be predetermined before applying energy to the object. Alternatively or additionally, the location, orientation, and configuration of each radiating element may be dynamically adjusted, for example, by using a processor, during operation of the apparatus and/or between rounds of energy application.

In some embodiments, an apparatus for applying RF energy may include a first radiating element located in a first waveguide feeding structure and a second radiating element located optionally in proximity to a wall on opposite side to the first waveguide feeding structure. The second radiating element may be located in a second waveguide feeding structure. The second radiating element may be configured to receive at least some of the RF energy emitted from the first radiating element. A portion of the RF energy emitted from the first radiating element may pass through the energy application zone (e.g., waveguide type energy application zone) and may be received at the second radiating element. Other portions of the RF energy emitted from the first radiating element may be reflected back to the first radiating element and dissipated (absorbed) in an object placed in the energy application zone. In some embodiments, there may be at least one pair of waveguide feeding structures, where each one of the pair of structures may include at least one radiating element or at least one feed. Optionally, the waveguide feeding structures may be located opposite to each other on two ends of the energy application zone that is located within a waveguide. When two waveguide feeding structures, each including at least one radiating element, are provided in two different places in the periphery of the energy application zone, some of the energy emitted from a first radiating element (located in a first waveguide feeding structure) may travel through the energy application zone and received by the second radiating element optionally located in a second waveguide feeding structure, and vice versa. Additionally or alternatively, a portion (e.g., a small portion) of the energy emitted from one port in a radiating element may be received at a second port of the same radiating element. Additionally or alternatively, a portion of the energy emitted from a first radiating element located at a waveguide feeding structure may be received by a second radiating element located at the same waveguide feeding structure (see FIG. 4A). The energy application zone in this case may constitute a waveguide that supports propagating (traveling) modes and may be analyzed as such. This type of energy application zone may be referred to herein as a waveguide-type energy application zone. An object that may be placed in a waveguide-type energy application zone may absorb at least a portion of the RF energy that travels through the zone, e.g., from one radiating element to another.

Some embodiments may include one or more electrically conductive elements located within the waveguide feeding structure and configured to electrically divide the aperture of the waveguide feeding structure into two or more sections. The electrically conductive elements may comprise electrically conductive materials, for example metals, alloys, graphite, etc. The electrically conductive element may be connected between two opposite walls of the waveguide feeding structure, optionally in a direction perpendicular to the wave propagation front. The conductive elements may have a shape of a rod or any other suitable shape, and may have any suitable cross sectional configuration.

A single conductive element may electrically divide the waveguide feeding structure aperture into two apertures, such that RF energy may propagate through and enter the energy application zone. A conductive element placed in a propagating electromagnetic field in a waveguide may split the propagating wave stream into two streams. For example, if a TE₀₁ mode is excited in a waveguide via a radiating element placed in the center of the aperture, a conductive element placed near the radiating element may electrically divide the aperture into two sections. However, in some embodiments where the radiating element is not located in the center of either of the apertures (i.e., the two divided sections), the modes excited in the apertures may include modes other than TE₀₁. In order to excite TE₀₁ in each new aperture, two radiating elements may be placed in the center of each of the two apertures. Alternatively, a single radiating element having two ports (i.e., a dual-port radiating element) each located in the center of a respective aperture may be used. In some embodiments, more than one conductive element may be placed in the waveguide feeding structure, thus dividing the structure into at least three sections. Optionally, at least one radiating element or at least one port of a radiating element may be located in each of the divided sections. Each section may have a width that is at least half a wavelength of the applied RF energy. If a range of frequencies are used, the wavelength referred to above is associated with the lowest frequency of that range. For example, if frequencies between 902 MHZ and 928 MHz are used, the lowest frequency may be 902 MHz. In some embodiments, the width of each section is a multiple of half a wavelength.

In some embodiments, an apparatus for applying RF energy may include at least two waveguide feeding structures located at different and optionally opposite sides of an energy application zone. The structures may have apertures with a cross section such that only a portion of the RF energy emitted from a radiating element travels through a portion of the energy application zone in which an object is placed. In such embodiments, little or no processing of the object may occur in portions of the energy application zone where RF energy does not travel. In some embodiments, in order to increase an amount of RF energy absorbed in the object, each waveguide feeding structure may be divided into at least two sections, and each section may include at least one radiating element or at least one port of a radiating element. For example, a first portion of the RF energy emitted from a first radiating element or port in a first waveguide feeding structure may travel through the object in the energy application zone, and may be at least partially absorbed in the object. A second portion of the RF emitted energy may be reflected back to the first radiating element or port. The rest of the emitted energy may be received by the radiating elements or ports of the second waveguide feeding structure, or the other radiating elements or port of the first waveguide feeding structure.

Reference is now made to FIG. 1F that includes a diagrammatic presentation of a top view of apparatus 100 for applying RF energy, according to some embodiments of the invention. Apparatus 100 may include a cavity 110, having a front wall (marked “FRONT”) where the door (not shown) may be located, a back wall (marked BACK) facing the front, and left and right sidewalls (marked LEFT and RIGHT, respectively). In the reference labels of FIG. 1F, the letters B, F, L and R are used to denote that the respective parts are associated with the back, front, left, and right sides of cavity 110. Apparatus 100 may further include left and right radiating elements 130L and 130R, respectively, and left and right electrically conductive elements 140L and 140R respectively. The other parts shown in the drawing may be imaginary or conceptually, although in some embodiments they may overlap with physical parts. For example, cavity 110 may include an energy application zone extending between left and right reference lines 120L and 120R. These reference lines may overlap with partition 120 discussed below. Reference line 180 may divide cavity 110 into a front part (drawn below reference line 180) and a back part (drawn above reference line 180). Cavity 110 may further include, to the left of line 120L and to the right of line 120R, a left feeding structure and a right feeding structure, respectively. Each feeding structure may be divided, by the radiating element close to it, into a front section and a back section. For example, section 115BL is the back section of the left feeding structure and section 115FL is the front section of the left feeding structure. Each feeding structure may have a width going along a direction leading from the front to the back of cavity 110. The width may be measured between the radiating element and the cavity wall. For example, the width of section 115BL may be measured between radiating element 140L and the back wall of cavity 110 (marked “WIDTH” in FIG. 1F). Similarly, the width of section 115FR may be measured between radiating element 140R and the front wall of cavity 110, etc. Each section may have a width substantially equal to a half-wavelength of the radiation emitted into the energy application zone by the radiating elements.

It is contemplated that in some embodiments the dimension of the cavity as measured between the front and back walls is larger than its dimension as measured between the right and left walls, for example, by a factor of 1.5, 2, 3, or larger or intermediate factors. The width of each section, however, may be similar to the dimension of the cavity as measured between the right and left walls, and differ from it, for example, by 30% or less. In some embodiments, the width of each section is smaller than the distance between the two corresponding radiating elements, such that the waves propagate between the radiating elements along the long dimension of the section, which may be the short dimension of the cavity. In some embodiments, the width of each section is at least half a wavelength of the radiation emitted by the radiating elements and the dimension of the cavity as measured between the front and back walls is at least one wavelength. If many frequencies are used, the wavelength corresponds to the lowest frequency used.

Reference is now made to FIGS. 1A and 1B that include diagrammatic representations of a top view (FIG. 1A) and a side view (FIG. 1B) of apparatus 100 for applying RF energy, for example, to process an object placed in the apparatus, in accordance with some embodiments of the invention. Apparatus 100 may include a cavity 110. Cavity 110 may have a rectangular shape (as illustrated) or cylindrical or any other shape according to the purpose of apparatus 100. Cavity 100 may have a front wall comprising an opening for a door, a back wall facing the door opening, a top, bottom and two opposite sidewalls. The walls of cavity 110 may include any conductive material suitable for constructing a cavity, e.g., various steels, stainless steels, cast iron, aluminum alloys, or copper alloys. Optionally, the walls of cavity 110 may comprise a material transparent to RF energy (e.g., a dielectric material) and may be coated with a conductive material. A conductive material may be opaque and/or reflective to the applied RF radiation. In some embodiments, cavity 110 may include walls coated and/or covered with a protective coating made from materials transparent to RF radiation, e.g., metallic oxides. Cavity 110 may include at least one waveguide feeding structure 115 adjacent to a first wall, and optionally a second waveguide feeding structure 115 adjacent to a second wall. The second wall may be opposite to the first wall. For example, the first wall and the second wall may be the left and right sidewalls illustrated in FIGS. 1A and 1B. Waveguide feeding structures 115 may be defined by at least one of the side walls of cavity 110 and at least a portion of the back and front walls, as illustrated in FIG. 1A. Waveguide feeding structure 115 may have an opening to energy application zone 125. Energy application zone 125 may be a waveguide-type energy application zone. A partition 120 may separate between energy application zone 120 and waveguide feeding structure 115. The separation may be physical, so as to prevent moisture from getting to the waveguide feeding structure from the energy application zone. Partition 120 may comprise any material transparent to RF radiation (i.e., capable of delivering at least a portion of the RF energy excited in waveguide feeding structure 115 to energy application zone 125). Optionally, partition 120 may include at least one window made from or otherwise including a material transparent to RF radiation. An object to be processed may be placed in energy application zone 125, for example through the door opening in cavity 110. Partition 120 may protect the radiating elements and other devices (e.g., other electronic devices) from the atmosphere in the presence of the object, for example, water and oil vapors that may evaporate from food during cooking.

Each waveguide feeding structure 115 may include at least one radiating element, e.g., 130a and 103b, collectively referred to as 130. In some embodiments, a first radiating element 130a may be installed in apparatus 100, optionally adjacent to a first wall, and a second radiating element 130b may be installed adjacent to a second wall. The second element may be configured to receive RF energy emitted from the first element. For example, radiating element 130b may be configured to receive RF energy emitted from first element 130a.

A side view of an exemplary radiating element in accordance with some embodiments of the invention is illustrated in FIG. 1C. First and second radiating elements 130a and 130b may each be located adjacent to the first and second wall in cavity 110 respectively, for example, adjacent to each of the side walls in the centers of waveguide feeding structures 115, as illustrated. In some embodiments, more than one radiating element may be located in structure 115. In some embodiments, the conducting rods may cause RF radiation to concentrate closer to the center of the cavity than in the absence of the electrically conductive elements. For example, in absence of the conducting rods only a small portion of the energy excited in waveguide feeding structures 115 (e.g., by radiating elements 130) may pass through and dissipate in an object placed in energy application zone 125. The propagation direction of a travelling wave excited in the cavity may have maxima of energy intensity in areas not occupied by the object, but rather, near walls of cavity 110. In order to process the object, the RF emission and the wave flow lines may be manipulated in order to cause the energy maxima to at least partially overlap with the object. In some embodiments, such manipulation may be accomplished by at least one conductive element 140 included in waveguide feeding structure 115.

At least one conductive element 140 may be configured to electrically divide the aperture of waveguide feeding structure 115 into sections (e.g., sections and manipulate the propagation directions of the emitted waves and/or the intensity distribution of the waves in a plane perpendicular to the propagation direction of the waves. Optionally, each waveguide feeding structure 115 may include conductive element(s) 140. Conductive element 140 may be connected between the top wall and the bottom wall of cavity 110 inside waveguide feeding structure 115. Element 140 may be considered inside structure 115 when the element is placed such that it divides the aperture of waveguide feeding structure 115 into at least two apertures. Conductive elements 140 may electrically divide the aperture of waveguide feeding structures 115, symmetrically (as illustrated) into even sections, or asymmetrically into odd sections. Conductive element 140 may be positioned with respect to one of the radiating elements such that conductive element 140 is electrically isolated from the radiating element. Conductive element 140, however, may affect the propagation pattern of the RF waves emitted from the radiating element. In some embodiments, conductive element 140 may be along a line connecting two radiating ports, or in proximity to such a line. In this respect, “in proximity” may mean closer to the line than to the center of the energy application zone, for example, closer by a factor of 2, 5, 10, or any intermediate or larger number.

Conductive element 140 may take the form of a rod, string, wall, etc. Conductive element 140 may electrically divide the aperture of waveguide feeding structure 115 into at least two sections (as illustrated in FIG. 1A). In some embodiments, more than one conductive element (e.g., three elements) may be installed in structure 115, as illustrated for example in the right feeding structure 115 in FIG. 1A. Conductive elements 140 may be located on both sides (e.g., energy application side and wall side) of radiating element 130. In some embodiments, conductive elements 140 may be only at the side of radiating element 130 that is near the wall. If two conductive elements are installed at a distance less than quarter of a wavelength of the RF wave emitted from the radiating element (or the wavelength corresponding to the central frequency in a band of frequencies emitted from the radiating element), the conductive elements may have the same effect as a complete wall (i.e., no RF waves may travel between the two sections). Different conductive elements (of the same feeding structure or of different feeding structures) may differ from each other (e.g., may be comprised of different material, have different shape or dimensions etc.), or may be similar to each other (e.g., in composition, shape, dimensions, etc.).

As illustrated in FIG. 1C, radiating element 130 may include at least two ports 134 each configured to emit RF energy to each of the divided sections of waveguide feeding structure 115 and/or receive RF energy from energy application zone 125. The distance between the two ports may be a half-wavelength of the RF waves emitted by the radiating element, or half of a wavelength corresponding to the central frequency in a band of frequencies emitted by the radiating element. Radiating element 130 may further include feed 132 for feeding RF energy from a power source (i.e., a RF power source) to radiating element 130 (e.g., to radiating ports 134 of element 130). In some embodiments, feed 132 may include a coaxial cable.

As shown in FIG. 1A, a first radiating element 130a may be placed in the left waveguide feeding structure 115 and may emit RF energy from two ports 134 into the two divided section of structure 115. For example, in FIG. 1A, the two divided sections of structure 115 are illustrated as the upper halves of structure 115 above reference line 180 and lower halves of structure 115 below reference line 180. A second radiating element 130b may be provided in the right waveguide feeding structure 115 and may emit RF energy from two ports 134 into the two divided sections of structure 115. RF waves emitted from element 130a, with propagation directions indicated by the solid line arrows, may pass through zone 125 and may be received in the two ports of radiating element 130b. Similarly, RF waves emitted from element 130b may be received by element 130a, as illustrated by the dashed line arrows. As shown in FIG. 1A, RF waves emitted from the port of radiating element 130a illustrated in the upper portion above reference line 180 may pass though zone 125 and received by both the upper (above reference line 180) and lower (below reference line 180) ports of radiating element Conversely, RF waves emitted from the lower port of radiating element 130a may also be received by both the lower and upper ports of radiating element 130b. These are illustrated by the solid line arrows in FIGS. 1A and 1B. Similarly, RF waves emitted from either of the lower or upper ports of radiating element 130b may be received by both by the lower and upper ports of radiating element 130b, as illustrated by the dashed line arrows (in FIGS. 1A and 1B). In addition, some of the RF waves emitted from the lower port in either radiating elements may also be received in the upper port of the same radiating element and vice versa. If the first (left 130a) and second (right 130b) radiating elements are emitting RF energy simultaneously—in some embodiments, the two emissions may or may not be coherent to each other. For example, RF energy may be emitted from the right radiating element 130b at frequency f1 and from the left radiating element 130a at frequency f2, wherein f1≠f2.

Cavity 110 comprising emitting and receiving radiating elements may be a waveguide-type energy application zone (e.g., zone 125), configured to support RF energy propagation (e.g., traveling waves). The waveguide-type energy application zone may encompass part of the void in the cavity (e.g., as illustrated in FIG. 1). If an object is placed in energy application zone 125, the RF energy emissions from both the first and the second radiating elements (130a and 130b) may travel through the zone and at least partially be absorbed by the object.

In some embodiments, apparatus 100 may include more than two waveguide feeding structures (more than one pair of structures). For example, an apparatus 100 including two pairs of waveguide feeding structures, two structures 115 and two structures 121, is illustrated in FIGS. 1D (top view) and 1E (side view). Waveguide feeding structures 121 may be located at third and fourth walls of cavity 110, for example at the top and bottom walls of cavity 110, as shown in FIG. 1E. Each of waveguide feeding structures 121 may include at least one radiating element (e.g., 130c, 130d) and at least one conductive element 140 configured to divide the aperture of each structure 121 into at least two sections acting as two waveguides. As discussed above, structures 115 may include at least one radiating element (130a, 130b) and at least one conductive element 140. The radiating elements may be adjacent to the third (e.g., top) and fourth (e.g., bottom) walls of cavity 110. Additional conductive elements 140 may be located in each of structures 121, for example connected between the front and the back walls of cavity 110. Electrically conductive elements 140 may divide waveguide feeding structures 121 to substantially equal sections. For example, RF energy emitted by radiating element 130c may propagate in the energy application zone and may travel through and at least partially dissipated in the object. The RF energy not dissipated in the object may be received by one or more of the other radiating elements 130a, 130b and/or 130d, or reflected back to 130c.

It is noted that different radiating elements of apparatus 100 may be identical to each other or may differ from each other (e.g., may be comprised of different materials, have different shapes or dimensions, and may be configured to emit the same frequency band or different frequency bands etc.).

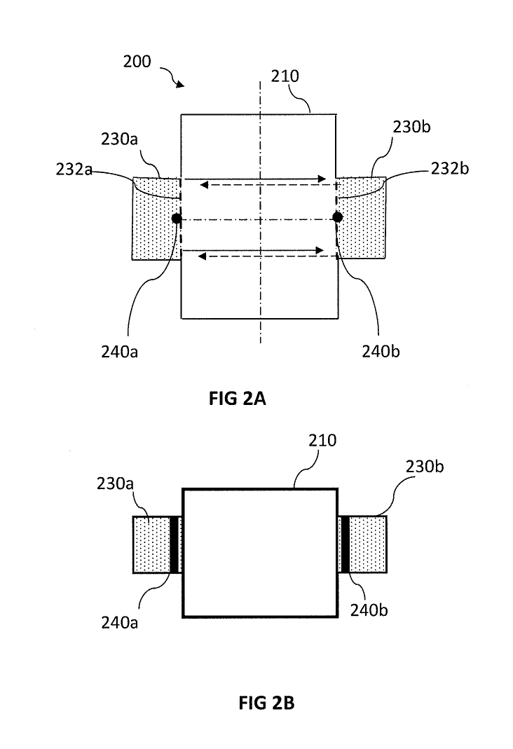

FIGS. 2A and 2B provide diagrammatic representations of the top view and side view of apparatus 200 for applying RF energy to an energy application zone via waveguide feeding structures. Apparatus 200 may include cavity 210. In some embodiments, cavity 210 may be a waveguide-type energy application zone. A waveguide-type energy application zone may include a structure configured to support propagation of RF radiation from one radiating element to another, for example, when radiation is emitted from one of the radiating elements alone, or when the two radiating elements radiate at the same time but non-coherently (e.g., at different frequencies). In some other embodiments, cavity 210 may be of a resonator type, for example, when two radiating elements radiate coherently into the energy application zone and a standing wave forms in the resonator. Cavity 210 may have a rectangular, cylindrical or other shape. Cavity 210 may include at least one conductive wall, for example, similar to cavity 110 illustrated in FIGS. 1A and 1B. An object to be processed by RF energy may be placed inside cavity 210. At least two waveguides feeding structures 230 may be connected to cavity 210, optionally on two opposite sides of cavity 210, as illustrated in FIGS. 2A and 2B. RF energy applied to cavity 210 from a first waveguide feeding structure 230a may travel through cavity 210 to a second waveguide feeding structure 230b, and vice versa. Waveguide feeding structures 230a and 230b may be collectively referred to as waveguide feeding structures 230. The solid and dashed arrows in FIG. 2A indicate the RF energy flow directions. Apparatus 200 may differ from apparatus 100 in the relationship between the cavity and the waveguide feeding structure. In apparatus 100, the waveguide feeding structures (115) constitute part of the cavity (110), whereas in apparatus 200, the waveguide feeding structures (230) are external to the cavity (210). Apertures 232a and 232b allow RF radiation from the waveguide feeding structures 230 into cavity 210. Each aperture may include an opening in the cavity wall. An aperture may further include RF transparent windows. An RF transparent window may be made of any dielectric material capable of transferring at least a portion of the RF energy emitted to the cavity. Some examples of RF transparent materials include glasses, heat resistant polymers, ceramics and combinations thereof.

In some embodiments, waveguide feeding structures 230 may have a cross section that enables application of RF energy to cavity 210 in at least one mode (e.g., TE₀₁, TE₀₂ and TE₁₁). In some embodiments, when an object is placed in cavity 210, the RF waves may propagate in cavity 210, and only a small portion of the energy applied by waveguides feeding structure 230 may travel through and dissipate in the object. In some embodiments, one or more conductive elements 240 may be located in waveguide feeding structure 230, dividing the aperture of waveguide feeding structure 230 into at least two sections. Each of the two sections may act as a waveguide feeding structure configured to apply RF energy to cavity 210. The RF waves propagating from each of the divided sections in waveguide feeding structures 230 may travel through the object and, thus, may allow at least a portion of the RF energy to be absorbed in at least a portion of the object resulting in processing of the object. Conductive elements 240 may electrically divide the aperture of waveguide feeding structures 230, symmetrically (as illustrated) or not symmetrically to even or odd sections. In some embodiments, an RF transparent partition may be located between apertures 232a and 232b of waveguide feeding structures 230a and 230b.

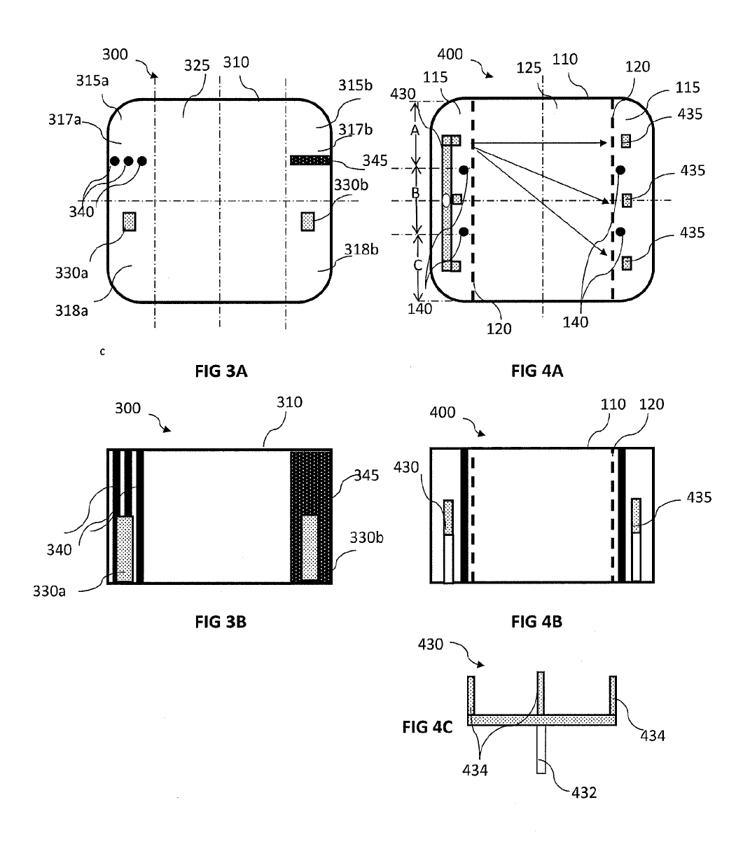

Some exemplary apparatuses in accordance with some embodiments of the invention may include conductive elements that may electrically divide an aperture of a waveguide feeding structure into two odd (i.e., un-even) sections. FIGS. 3A and 3B show a top view and side view of such an apparatus (apparatus 300). Apparatus 300 may include a rectangular cavity 310. Energy application zone 325 may be a waveguide type energy application zone and may have the same characteristics as energy application zone 125 illustrated in FIGS. 1A and 1B. Cavity 310 may comprise at least two waveguide feeding structures 315a and 315b, collectively referred to as waveguide feeding structures 315. Waveguide feeding structures 315 may be configured to support the excitation, feeding and emission of propagating waves to energy application zone 325. Waveguide feeding structures 315 may have an opening to zone 325 that may or may not include a partition separating the waveguide feeding structure from energy application zone 325. Waveguide feeding structure 315 may support the propagation of at least one mode (e.g., TE₀₁). In some embodiments, when an object is placed in zone 325, the RF waves may propagate in cavity 310 (e.g., in zone 325 within the cavity), and only small portion of the energy excited in waveguide feeding structures 315 (e.g., by radiating elements 330) may travel through and dissipated in the object. The RF wave flow directions and the excitation of propagating waves (e.g., the excitation of one or more modes) in waveguide feeding structure 315 may be manipulated by including conductive elements 340 and/or 345 in waveguide feeding structures 315. In some embodiments, a waveguide feeding structure including conductive elements may increase the dissipation (absorption) of energy in the object compared to waveguide feeding structure not including conductive elements.

Conductive element 340 may electrically divide the aperture of waveguide feeding structure 315a into two un-even sections 317a (the area between electrically conductive element 340 and the cavity wall as shown in the upper left corner of the figure) and 318a (the area between electrically conductive element 340 and the cavity wall as shown in the lower left corner of the figure). Similarly, conductive element 345 may electrically divide the aperture of waveguide feeding structure 315b into two un-even sections 317b (the area between electrically conductive element 345 and the cavity wall shown in the upper right corner of the figure) and 318b (the area between electrically conductive element 345 and the wall shown in the lower right corner of the figure). As shown in FIG. 3A, the aperture of each of sections 318a and 318b is larger than the aperture of its corresponding sections 317a and 317b, respectively. At least one radiating element, e.g., 330a may be placed in one of the sections, e.g., 318a, optionally adjacent to the cavity wall. Propagating RF waves may be emitted from radiating element 330a and delivered into zone 325 via the aperture of section 318a, while little or no RF energy may be delivered from the aperture of section 317a. Radiating element 330a may be fed from the top wall (e.g., the ceiling) of cavity 310. Energy emitted from radiating element 330a may propagate through zone 325 and received by radiating element 330b in section 318b. In some embodiments, both radiating elements 330a and 330b may emit energy at the same time. The emissions may be at the same frequency, which may result in coherent emission, or at different frequencies, which may result in non-coherent emission. In some embodiments, energy is applied through one of the radiating elements (e.g., 330a) when the other is silent.

In some embodiments, two or more (e.g., three) rod-shaped conductive elements 340 may be installed in a row perpendicular to the aperture of waveguide feeding structure 315, electrically dividing the aperture into two sections such as 317a and 318b. Elements 340 may include metallic rods having any suitable cross section (e.g., a circle or rectangular). Elements 340 may be connected between the top and bottom walls of cavity 310 inside waveguide feeding structure 315. An electrically conductive element may be considered “inside” structures 315 when the elements are placed such that the aperture of waveguide feeding structure 315 may be electrically divided into at least two apertures. Element 345 is shown in the figure to have a wall shape, but may also have any other appropriate shapes.

In some embodiments, an apparatus for applying RF energy may include at least one waveguide feeding structure (e.g., structures 115, 121, or 315) provided as part of the cavity and at least one external waveguide feeding structure (e.g., waveguide feeding structure 230) provided externally to the cavity, optionally adjacent to a wall of the cavity opposite to the waveguide feeding structure. RF waves emitted (e.g., from a radiating element) in the waveguide feeding structure may travel through an energy application zone (e.g., a waveguide type zone) and received by the external waveguide feeding structure and vice versa. Each of the waveguide feeding structure may include one or more conductive elements configured to electrically divide the waveguide feeding structure into two or more sections (as discussed above).

Referring now to FIGS. 4A (top view) and 4B (side view) illustrating apparatus 400 for applying RF energy to process an object, in accordance with some embodiments of the invention. Apparatus 400 may include cavity 110, discussed in reference to FIGS. 1A and 1B. As disclosed, cavity 110 may include two waveguide feeding structures 115, and partitions 120 that may separate structures 115 from energy application zone 125. In some embodiments, the aperture of each of waveguide feeding structures 115 may be electrically divided into more than two sections using more than one conductive element 140. For example, when a feeding structure (e.g., feeding structure 115) includes two conductive elements (e.g., conductive elements 140)—the structure may be electrically divided into three sections (for example—sections A, B, and C illustrated in FIG. 4A). Each section may have a width that is at least half-wavelength of RF radiation applied to the energy application zone through the radiating elements 430. The width of the central section (B) may be, for example, between the two electrically conductive elements 140 at the left hand side of FIG. 4A. The sections may have substantially the same dimensions (even sections) or may have different dimensions (un-even/odd sections). In the exemplary embodiment shown in FIG. 4A, the three sections are of substantially equal widths. In some embodiments, three radiating elements 435 each having a single port may be located in each of the divided sections, optionally adjacent to cavity 110 wall, such as illustrated in the right waveguide feeding structure 115 in FIG. 4A. In some embodiments, a single radiating element 430 having 3 ports may be provided in waveguide feeding structure 115 such that each port may feed RF energy to different section in the structure, such as illustrated in the left waveguide feeding structure 115 in FIG. 4A As shown in FIG. 4C, radiating element 430 may include three radiating ports 434, all receiving RF energy from a single feed 432. Feed 432 may be connected to the cavity walls, optionally inside waveguide feeding structure 115 and further connected to a power source (e.g., an RF power source). In some embodiments, feed 432 may include a coaxial cable.

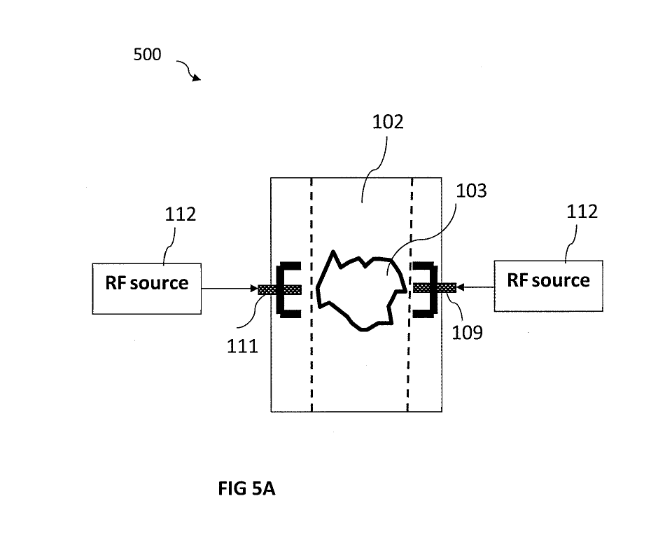

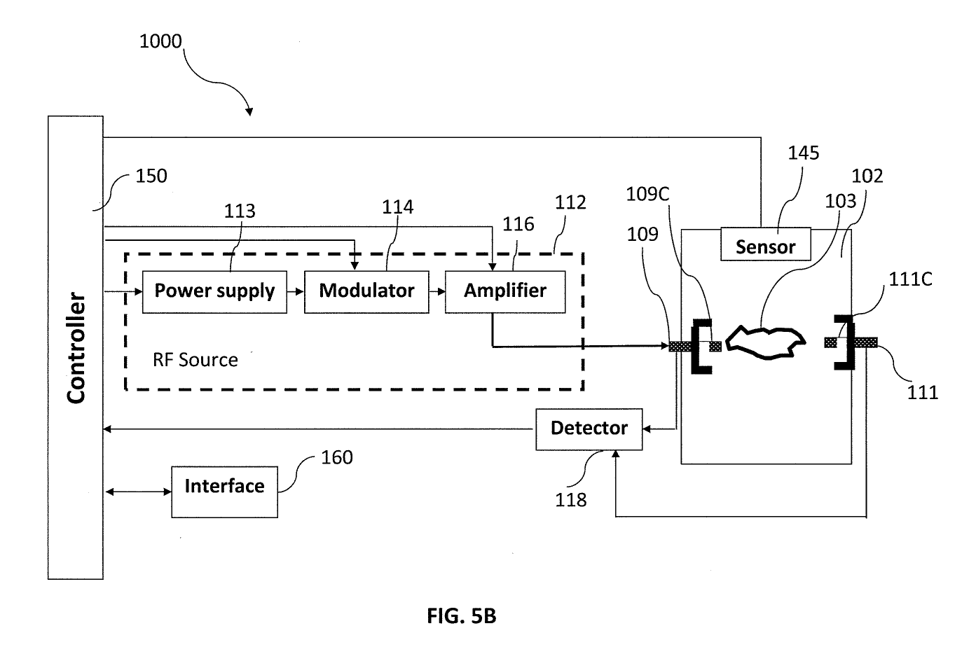

Reference is now made to FIG. 5A that includes a diagrammatic representation of a system 500 for applying RF energy to an object 103 placed in an energy application zone 102, in accordance with some embodiments of the invention. System 500 may include energy application zone 102. Energy application zone 102 may include any void, location, region, or area where electromagnetic energy may be applied. It may be hollow, or may be filled or partially filled with liquids, solids, gases, or combinations thereof. By way of example only, energy application zone 102 may include an interior of an enclosure, interior of a partial enclosure, open space, solid, or partial solid that allows existence, propagation, and/or resonance of electromagnetic waves. Zone 102 may include a conveyor belt or a rotating plate. Energy application zone 102 may constitute a waveguide type energy application zone, and thus, may be analyzed as “a waveguide.” In certain embodiments, electromagnetic energy may be applied to object 103 placed in energy application zone 102 to process the object. Object 103 may be considered placed in energy application zone 102, if at least a portion of object 103 is located in energy application zone 102. In some embodiments, the cavity, entirely or partially, may constitute the energy application zone.

In some embodiments, a portion of electromagnetic energy applied to energy application zone 102 may be absorbed by object 103. In some embodiments, another portion of the electromagnetic energy applied or delivered to energy application zone 102 may be absorbed by various elements (e.g., food residue, particle residue, additional objects, structures associated with zone 102, or any other electromagnetic energy-absorbing materials found in zone 102) associated with energy application zone 102. Energy application zone 102 may also include other loss constituents for example, cracks, seams, joints, doors, an interface between a door in a cavity body or any other loss mechanisms associated with energy application zone 102. These other loss constitutes are believed not to absorb an appreciable amount of electromagnetic energy.

Exemplary system 500 may be part of an oven (e.g., cooking oven), chamber, tank, dryer, thawer, dehydrator, reactor, engine, filter, chemical or biological processing apparatus, furnace, incinerator, material shaping or forming apparatus, conveyor, combustion zone, cooler, freezer, etc. System 500 may include an apparatus for applying RF energy to an object, for example, apparatus 100, 200, 300, 400, or 900, described in this disclosure. In some embodiments, energy application zone 102 may be part of a vending machine, in which objects are processed once purchased. In some embodiments, energy application zone 102 may include or be an electromagnetic resonator (also known as a “cavity resonator”). Alternatively, energy application zone 102 may be included in a cavity configured to support mainly propagating waves (i.e., traveling waves), rather than resonating waves (i.e., standing waves). At times, energy application zone 102 may be congruent with the object or a portion of the object (e.g., the object or a portion thereof may define the energy application zone).

System 500 may include one or more of radiating elements. Two radiating elements, 109 and 111 are shown in FIG. 5A. Each of the radiating elements (i.e., 109 and/or 111) may be configured to apply (emit) RF energy from the corresponding RF source to energy application zone 102, in which case it may be referred to as “emitter” or “emitting radiating elements”. Radiating elements 109 and/or 111 may be similar to radiating elements 130, 330, 430, and 435 and may be included in a waveguide feeding structure as discussed above. Energy application zone 102 may be similar to zone 125 and 325 as discussed above. Radiating elements 109 and/or 111 may be any element, system, array of elements, etc. designed or configured to emit or deliver RF energy. In addition, radiating elements 109 and/or 111 may be further configured to receive RF energy from zone 102, in which case they may be referred to as “receivers” or “receiving radiating elements”). For example, radiating element 109 may receive RF energy emitted by radiating element 111 and vice versa. Each of radiating elements 109 and/or 111 may be any of an antenna, an array of antennas, and an RF feed. In some embodiments, more than one antenna and/or a plurality of radiating elements (e.g., antennas) may be provided (e.g., radiating elements 109 and 111 illustrated in FIG. 5A) in or associated with the energy application zone (e.g., zone 102).

RF energy may be supplied to radiating element(s) (e.g., 109 and 111) by one or more RF sources 112. Each RF source 112 may be any system configured to supply electromagnetic energy to the energy application zone, e.g., to a radiating element. An RF source (also referred to herein as a source) may include any component(s) that is suitable for generating and supplying electromagnetic energy, for example: a magnetron, semiconductor oscillator, electromagnetic field generator, solid-state power amplifier, electromagnetic flux generator, or any mechanism for generating vibrating electrons.

In some embodiments, the RF energy applied to the energy application zone may be controlled based on electromagnetic feedback received from the zone.

FIG. 5B provides a block diagram of a system 1000 for controlling RF energy application to an energy application zone, in accordance with some embodiments of the invention. System 1000 may include an apparatus for applying RF energy as described herein, for example, apparatus 100, 200, 300, 400, or 900. System 1000 may include energy application zone 102. Object 103 to be processed by system 1000 may be placed in zone 102 entirely or partially. RF energy may be emitted to zone 102 from radiating elements 109, as discussed above in respect to system 500 of FIG. 5A. However, different from system 500, radiating element 111 in system 1000 is not connected to an RF source, and therefore, may operate only as a receiving radiating element. Conductive radiating elements as discussed above may be positioned between the two ports of radiating element 109 (conductive element 109C) and between the two ports of radiating element 111 (conductive element 111C). System 1000 may further include a source (e.g., RF source 112) for supplying RF energy to the radiating elements 109 and 111. Optionally, all radiating elements are connected to a single RF source. Alternatively, each radiating element is connected to its own RF source. Still alternatively, one or more of the radiating elements may not be connected to any RF source. The source may include one or more of a power supply 113 configured to generate electromagnetic waves that carry electromagnetic energy. For example, power supply 113 may include a magnetron configured to generate high power microwave waves at a predetermined wavelength or frequency. Alternatively, or additionally, power supply 113 may include a semiconductor oscillator, e.g., a voltage controlled oscillator, configured to generate AC waveforms (e.g., AC voltage or current) with a controllable frequency. In some embodiments, the controlled frequency may be constant or time-varying. The generated AC waveforms may include sinusoidal waves, square waves, pulsed waves, triangular waves, or another type of waveforms with alternating polarities.

Consistent with some embodiments, RF energy may be supplied to the energy application zone in the form of propagating electromagnetic waves at predetermined wavelengths or frequencies (also known as electromagnetic radiation). Electromagnetic radiation carries energy that may be imparted to (or dissipated into) matter with which it interacts.

As used herein, if a machine (e.g., a controller) is described as “configured to” perform a task (e.g., configured to cause application of a predetermined wave propagation mode), it is contemplated that the machine includes the components or elements (e.g., parts, software, etc.) needed to make the machine capable of performing the described task during operation. In some embodiments, the machine may also perform this task during operation. Similarly, when a task is described as being done “in order to” establish a target result (e.g., in order to apply RF energy in a plurality of frequencies and modes to the object), such a description associates the task with the target result. In some embodiments, the target result may be fully or partially accomplished through performing the task.

In some embodiments, source 112 may further include at least one modulator 114 and/or at least one amplifier 116. Modulator 114 may be a phase modulator, a frequency modulator, an amplitude modulator, an oscillator or any other modulator configured to modulate (e.g., regulate, adjust, control, or vary) at least one aspect of the RF energy delivery (e.g., the frequency of the RF radiation, the phase difference between radiation emitted by pair of radiating elements, the power level at which the RF energy is applied, the amplitude differences between signals emitted by two of the radiating elements, etc.). Amplifier 116 may be any apparatus configured to change the amplitude of the RF waves supplied by the power supply. Amplifier 116 may be a solid-state power amplifier. It is contemplated that source 112 may include only one component or more than one component or any combination of components according to the demand of invention particular embodiment. The power supply, the modulator and the amplifier may each be controlled by a controller (e.g. controller 150), as will be discussed below.

System 1000 may further include at least one sensor 145. Sensor 145 may be installed in or around energy application zone 102. Sensor 145 may be installed in or around object 103. Sensor 145 may be configured to detect and/or measure a feedback (e.g., electromagnetic feedback) in accordance with some embodiments of the invention, for example, the intensity of electromagnetic field excited in the energy application zone, e.g., at the point where the sensor is located. Additionally or alternatively, sensor 145 may be configured to detect and/or measure other signals or feedbacks relating to object 103 and/or energy application zone 102. For example, sensor 145 may include a thermometer configured to measure the temperature of object 102 and/or energy application zone 102 (e.g., a thermocouple or an IR sensor). In some embodiments, sensor 145 may include a humidity sensor, a pressure sensor (e.g., a barometer), a pH sensor configured to measure the pH of a solution when the object comprises liquids. In some embodiments, sensor 145 may be configured to measure the weight of at least a portion of the object (e.g., a scale). Sensor 145 may be configured to measure any detectable and measurable property of the object or the energy application zone. Sensor 145 may be configured to send feedback signals to controller 150.

In some embodiments, System 1000 may further include a controller 150. As used herein, the term “controller” is used interchangeably with the term “processor” and may include any electric circuit that performs a logic operation on input or inputs. For example, such a controller may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations.

The instructions executed by the controller may, for example, be pre-loaded into a controller or may be stored in a separate memory unit, such as a RAM, a ROM, a hard disk, an optical disk, a magnetic medium, a flash memory, other permanent, fixed, or volatile memory, or any other mechanism capable of storing instructions for the controller. The separate memory unit may or may not be a part of the controller. The controller(s) may be customized for a particular use, or can be configured for general-purpose use and can perform different functions by executing different software.

If more than one controller or processor is employed, all may be of similar construction, or they may be of differing constructions electrically connected or disconnected from each other. They may be separate circuits or integrated in a single circuit. When more than one controller or processor is used, they may be configured to operate independently or collaboratively. They may be coupled electrically, magnetically, optically, acoustically, mechanically or by other means permitting them to interact.

In some embodiments, at least one controller may be configured to cause RF energy application via at least one radiating element to the energy application zone. Controller(s) 150 may control at least one RF source (e.g., source 112) to supply RF energy to at least one radiating element (e.g., elements 109, 111, 130, 330, 430 or 435) to cause the radiating elements to emit RF energy to energy application zone 102.

In some embodiments, RF energy may be applied to zone 102 using various energy application parameters. An energy application parameter may be any parameter that may affect a field pattern or a wave mode excited in the energy application zone upon energy application. For example, an energy application parameter may include a frequency, a position or an orientation of a radiating element, and a phase or amplitude difference between signals emitted by two of the radiating elements, etc. The collection of all the combinations of all the possible values of all the energy application parameters controlled in a given energy application device may be referred to as a modulation space (MS) of the device. Each such parameter may be referred to herein as an MS dimension. For example, a three-dimensional modulation space may include three dimensions designated as frequency (F), phase (P), and amplitude (A). That is, frequency, phase, and amplitude (e.g., an amplitude difference between two or more waves being delivered at the same time) of the electromagnetic waves are modulated during energy application, while all the other parameters may be fixed during energy application. In one example, a one dimensional modulation space oven may provide variations in frequency only.

The term “modulation space element” or “MSE,” may refer to a specific set of values of the variable parameters in MS. Therefore, the MS may also be considered to be a collection of all possible MSEs. For example, two MSEs may differ one from another in the relative amplitudes of the energy being supplied to a plurality of radiating elements. Differing combinations of these MSE parameters will lead to differing modes propagating across the energy application zone and differing energy distribution patterns in the object. A plurality of MSEs that can be executed sequentially or simultaneously to excite a particular mode in the energy application zone may be collectively referred to as an “energy application protocol.” For example, an energy application protocol may consist of three MSEs: (F(1), A(1)); (F(2A(2)) (F(3), A(3)). Such an energy application protocol may result in applying the first, second, and third MSE to the energy application zone. As used herein, applying an MSE may refer to applying energy at an MSE, e.g., applying energy at a specific frequency or a frequency band.

Any number of MSEs or MSE combinations may be used in the disclosed embodiments. For example, various MSE combinations may be used depending on the requirements of a particular application and/or on a desired energy transfer profile, and/or given equipment, e.g., cavity dimensions. The number of options that may be employed could be as few as two or as many as the designer desires, depending on factors such as intended use, level of desired control, hardware or software resolution and cost.

In some embodiments, the controller may control the RF energy application by selecting a sub-group or sub-band of MSEs from a plurality of available MSEs. The MSEs available to a system (e.g., system 500 or 1000) may include all the modulation space elements at which RF energy may be applied. The selected MSEs may be included in an energy application protocol. The energy application protocol may further include assigning different or similar energy levels to the selected MSEs (weights), for example by varying respective durations in which a particular EM mode is propagating in the energy application zone. Additionally, or alternatively, different energy levels may be assigned to different MSEs by assigning different power levels for applying energy at each of the different MSEs.

Controller 150 may be configured to select a subgroup of MSEs for energy application and energy levels based on one or more rules. Some exemplary rules are discussed below. However, it is contemplated the invention in its broadest sense is not limited to any particular rule.

As used herein, the term electromagnetic feedback (EM feedback) may include any received signals indicative of the dielectric response of the cavity and/or the object to the applied RF energy—e.g., it may include or be indicative of energy absorbed by the object (e.g., at the particular MSE). The EM feedback may be MSE-dependent, for example, may include signals, the values of which vary over different MSEs. EM feedback may include, for example, input and output power levels, scattering parameters (a/k/a S parameters), and values derivable from the S parameters and/or from the power levels, e.g., input impedance, dissipation ratio, time or MSE derivative of any of them, or any other value that may be derivable or calculated (e.g., by mathematical calculation, such as an average value over a plurality of MSEs) from the received signals.

In certain embodiments, controller 150 may be configured to determine a value related to EM feedback at each of a plurality of MSEs. The value may be determined based on EM feedback signal received from the energy application zone during application of energy at a particular MSE. The value or the signal may each be considered as an EM feedback. Controller 150 may select MSEs and energy levels for application based on the EM feedback, and in some embodiments, also based on the energy application protocol. For example, controller 150 may be configured to cause RF energy application only at MSEs associated with values related to EM feedback higher than a lower threshold. Alternatively, or additionally, controller 150 may be configured to cause RF energy application at all MSEs associated with values lower than an upper threshold. In some embodiments, other values of EM feedback related parameters may be used to select the sub-group of MSEs. Additionally, or alternatively, additional rules (other than setting a threshold for values) may be applied. While the invention is not limited to any particular measure of EM feedback, various exemplary values of EM feedback related parameters are discussed below.

In order to associate a feedback value with a particular MSE, a sweep may be conducted. As used herein, a sweep may include, for example, the application over time of energy at more than one MSE. For example, a sweep may include the sequential application of energy at multiple MSEs in one or more contiguous MSE band; the sequential application of energy at multiple MSEs in more than one non-contiguous MSE band; the sequential application of energy at individual non-contiguous MSEs; and/or the application of synthesized pulses having a desired MSE/power spectral content (e.g., a synthesized pulse in time). The MSE bands may be contiguous or non-contiguous. Thus, during an MSE sweeping process, the at least one controller may regulate the energy supplied to the at least one radiating element to sequentially apply electromagnetic energy at various MSEs to zone 102, and to receive EM feedback values from zone 102 associated with each MSE.

During the sweeping process, controller 150 may receive from detector 118 feedback indicative of the electromagnetic energy reflected back and/or coupled to one or more of radiating elements (e.g., 111 and 109) (e.g., when applying energy at a plurality of MSEs). Controller 150 may then determine a value indicative of energy absorbable by object 103 at each of a plurality of MSEs based on the received feedback from detector 118. Detector 118 may be configured to measure any parameter related to the RF energy application, for example, the power, frequency, current, the input impedance, etc. In some embodiments, detector 118 may detect the time dependence of the measured variables, which may be mathematically expressed as complex values. In some embodiments, only magnitudes of the measured values that are mathematically expressed as real numbers, may be provided by the detector. Detector 118 may further include a coupler (e.g., dual-directional coupler) configured to separate between different signals received from different or the same radiating elements.

Consistent with some embodiments, a value indicative of EM feedback may include a dissipation ratio (referred to herein as “DR”) associated with each of a plurality of MSEs. As referred to herein, a “dissipation ratio” (or “absorption efficiency” or “power efficiency”), may be defined as a ratio between electromagnetic energy absorbed by object 103 and electromagnetic energy supplied into energy application zone 102. In some embodiments, a “dissipation ratio” may be defined as a ratio between electromagnetic energy absorbed by object 103 and electromagnetic energy delivered into energy application zone 102.

In some of the presently disclosed embodiments, a dissipation ratio may be calculated using Equation (1):

DR=A/S (1)

where S is the energy supplied to an emitting radiating element, and A is the energy absorbed in the object. Both S and A may be calculated by integrating over time the power detected by power detectors (e.g., detector 118). For t=ti, wherein ti may be any moment in time, during which energy is applied to the energy application zone, Equation (1) calculated for a first radiating element (e.g., element 109) may be:

DR=P_{A}/P_{S}; (1*)

where P_{A} is the power absorbed by the object and may be calculated by the difference between Pₛ, the power supplied to the first radiating element (e.g., element 109) from the RF source, and Pₒᵤₜ, the power reflected from the energy application zone and received by all the radiating elements (emitters e.g., element 109 and receivers e.g., element 111) as in Equation (2):

P_{A}=Pₛ−Pₒᵤₜ; (2)

where Pₒᵤₜ stands for the power reflected back and detected by all the detectors (e.g., radiating elements), denoted as P_{detect}, in and around the energy application zone, when Pₛ was supplied by the first radiating element at a certain MSE, as in Equation (3):

Pₒᵤₜ=ΣP_{detect} (3)

If the only available detectors are the ones associated with the radiating elements, DR may be calculated using three detected power parameters P_{S}, P_{R} and P_{C} and Equation (1*) may have the form of Equation (4):

DR=(P_{S}−P_{R}−P_{C})/P_{S} (4)

where P_{S} represents the power supplied to a radiating element 109, P_{R} represents the electromagnetic power reflected back to radiating element 109, and P_{C} represents the electromagnetic power coupled to the other radiating elements, acting as receivers, (e.g., radiating element 111). For example, in apparatus 100, Ps and Pr may be detected for radiating element 130a when element 130a emits energy to zone 125 and Pc may be detected in radiating element 130b, when 130b is silent (i.e., not emitting energy to the zone). DR may be a value between 0 and 1, and thus may be represented by a percentage number.

For example, consistent with the embodiment illustrated in FIG. 4A, in which three radiating elements 435 are provided, controller 150 may be configured to determine input reflection coefficients S₁₁, S₂₂, and S₃₃, etc., and transfer coefficients S₁₂, S₂₁, S₁₃, S₃₁, S₂₃, and S₃₂, etc. (referred to herein as S parameters). The S parameters may be determined based on measured power amplitudes, and in some embodiments, based on the time dependence of the voltages or currents going forward (to the cavity) and backward (from the cavity). Accordingly, the dissipation ratio DR corresponding to a first radiating element 435 when only the first element is emitting RF energy and the other elements are acting as receivers, may be calculated based on the above mentioned reflection and transmission coefficients, according to Equation (5):

DR₁=1−(IS₁₁I²+IS₁₂I²+IS₁₃I²). (5)

As shown in Equation (5), the dissipation ratio may be different at different radiating elements. Thus, in some embodiments, amount of energy supplied to a particular radiating element may be determined based on the dissipation ratio associated with that particular radiating element.

In certain embodiments, controller 150 may be further configured to determine an RF energy application protocol by adjusting the amount of RF energy supplied at each MSE based on the EM feedback. For example, controller 150 may use the dissipation ratio calculated for each MSE—DR(MSEᵢ)—to determine the amount of energy to be supplied to the radiating element at each MSEᵢ as a function of the DR(MSEᵢ). In some embodiments, processing of the object may include two stages. In the first stage, the EM feedback is detected and/or calculated (e.g, DR at each MSE). The EM feedback may be detected for each applied MSE, optionally while applying that MSE. The second stage may include energy application based on the EM feedback detected in the first stage and according to an energy application protocol or rule. The two stages may be repeated while the object is processed, e.g., for a few times a minute.

In some embodiments, the energy applied at MSEi may be inversely related to DR(MSEᵢ). Such an inverse relationship may also be applicable to other EM feedbacks. For example, when a value indicative of absorbable energy (e.g., a DR) in a particular MSE subset tends to be relatively low, the supplied energy at that particular MSE subset may be relatively high.

A value indicative of absorbable energy may also be an EM feedback related value indicative of the ability of the object to absorb RF energy. In that case, the substantially inverse relationship may be even more accurately applied. For example, the supplied energy may be set such that its product with the absorbable energy value (i.e., the absorbable energy by object 103) is substantially constant across the MSEs applied. In other embodiments, other relations (rules) may be applied, for example a constant amount of energy may be applied at least a sub-group of MSEs. Additionally or alternatively the EM feedback related value may be Zin, the input impedance measure on each radiating element that emits RF energy.

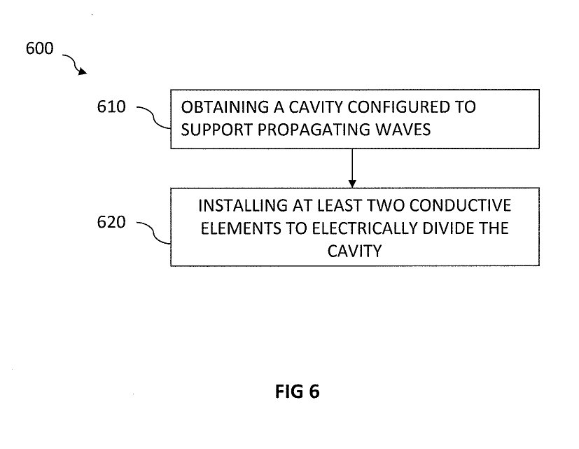

An aspect of some embodiments of the invention may include making and/or manufacturing an apparatus for applying RF energy to process an object placed in an energy application zone. FIG. 6 is a flowchart of method 600 for making an apparatus, in accordance with some embodiments of the invention. A cavity configured to support propagating or resonating RF waves may be obtained in step 601. In some embodiments, the cavity may include at least one waveguide feeding structures (e.g., structures 115, 121, or 315) each comprising at least one radiating element. The radiating element(s) may include more than one port for emitting RF energy. Alternatively or additionally, the cavity may be fed by at least one waveguide feeding structure (e.g., waveguide feeding structures 230). The cavity may include waveguide type energy application zone (e.g., zones 102 and 125). The cavity may be configured to hold at least a portion of an object to be processed. The RF energy may be emitted to the cavity by radiating elements or waveguides feed from RF energy source. The cavity may be part of system 500 or 1000 as discussed above.

In step 620, conductive element(s) may be installed in the obtained cavity to electrically divide the cavity and/or the waveguide feeding structure. In some embodiments, the conductive element(s) may be installed such that at least a portion of the RF energy applied from the waveguide feeding structures may process at least a portion of an object placed in the energy application zone. Conductive element(s) (e.g., elements 140, 240, 340 and 345) may be installed in at least one waveguide feeding structure or waveguide. In some embodiments, the conductive element may set the boundary between a waveguide feeding structure and the energy application zone. For example, the space on one side the conductive element may be the feeding structure, and on the other side—the energy application zone. The feeding structures may be a part of the cavity (such as illustrated in FIG. 1A) or external to the energy application zone (such as illustrated in FIG. 2A). The conductive elements may be installed so as to electrically divide the aperture of each waveguide feeding structure or waveguide into at least two sections. The sections may be substantially similar or may have mutually different dimensions. In some embodiments, more than two conductive elements may be installed in a waveguide or waveguide feeding structure.

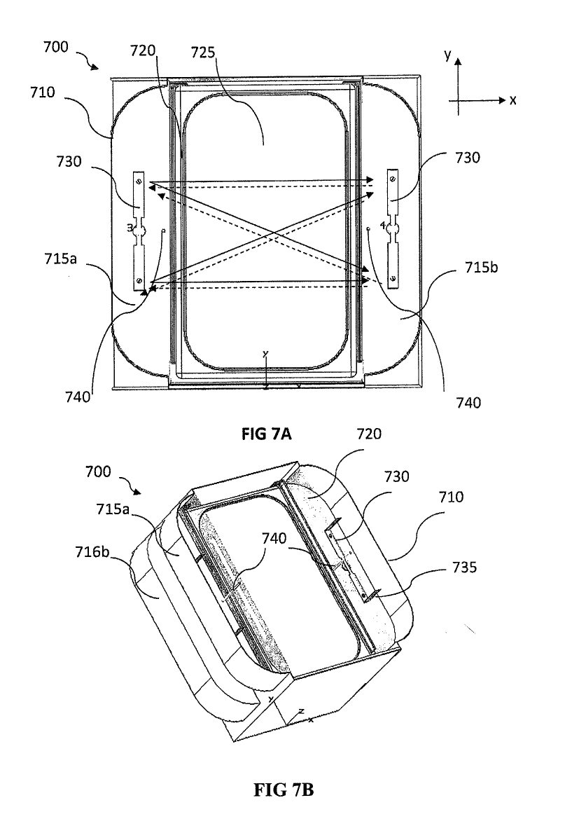

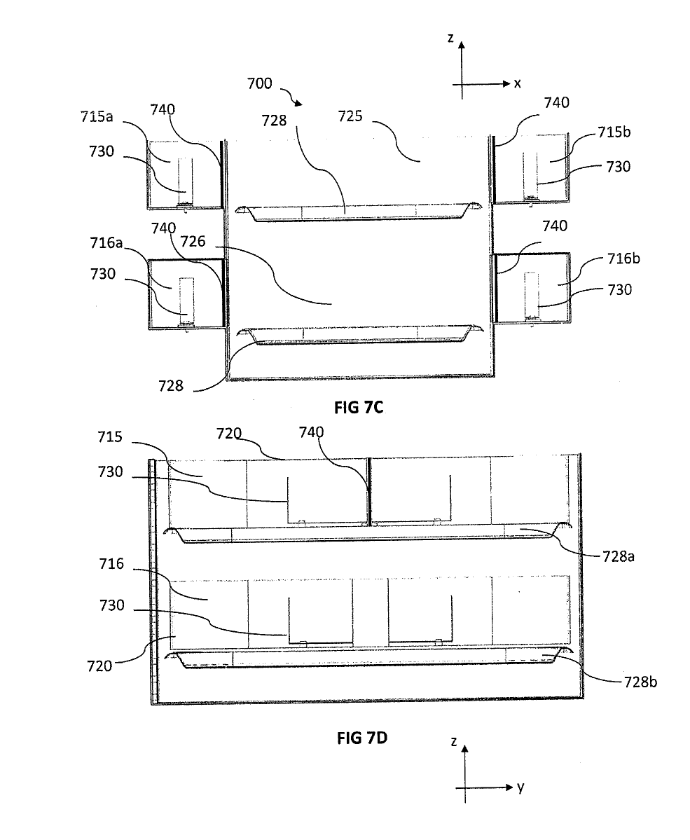

An exemplary apparatus 700 for applying RF energy to process an object is illustrated in FIGS. 7A-7D, in accordance with some embodiments of the invention. Apparatus 700 may include or be a part of a two-level oven, optionally for cooking food items. FIG. 7A is a top view drawing of apparatus 700, FIG. 7B is an isometric view, FIG. 7C is a front view (from the door side), and FIG. 7D is a side view of apparatus 700. Apparatus 700 may include a waveguide type-cavity 710 having a rectangular shape and made from a conductive material, for example stainless steel. Cavity 710 may include two pairs of waveguide feeding structures 715a, 715b and 716a, 716b, referred to collectively as structures 715 and structures 716, respectively. Structures 715 (e.g., structures 715a and 715b) may be located at the upper level of cavity 710 and structures 716 (e.g., structure 716a and 716b) may be located in the lower level of cavity 710. Each waveguide feeding structure may have an opening (aperture) to an energy application zone. For example, structures 715 may have openings to upper zone 725 and structures 716 may have openings to lower zone 726. The openings may be covered by an RF transparent material, such as partitioning 120 shown in FIG. 1 or partitioning 720 shown in FIG. 7A. Upper zone 725 may be defined by the cavity upper wall and an upper tray 728a. Lower zone 726 may be defined by upper and lower trays 728a and 728b. Different objects may be placed and processed simultaneously in the upper and lower energy application zones 725 and 726. For example, a loaf of bread may be placed on upper tray 728a and baked in upper zone 725, and a chicken may be placed on lower tray 728b and cooked in lower zone 726. All the waveguide feeding structures may include partitions 720 made of mica or other dielectric material to protect the radiating elements from contents of the energy application zone (e.g., vapor, oil drops, etc).

Each waveguide feeding structure may include one radiating element 730 located adjacent to cavity 710 walls, for example, in the center of each structure. The radiating elements may be configured to apply RF energy, e.g., in a working band around 900 or 1000 MHz. As shown in FIG. 7C, four radiating elements 730 may be installed in apparatus 700. However, in some embodiments, a portion of RF energy emitted from right upper radiating element 730 (located in structure 715b) may be received only by left upper radiating element 730 located in structure 715a, and vice versa, as shown by the solid and dashed arrows in FIG. 7A. Similarly, RF energy emitted from right lower radiating element 730 (located in structure 716b) may be received only by left lower radiating element 730 (located in structure 716a) and vice versa. The two levels may be substantially electrically separated by upper tray 728a. Upper and lower trays 728a and 728b may be constructed from a metallic alloy, for example, a SAE 304 or SAE 316 stainless steels.

Each waveguide feeding structure may further include at least one conductive element 740 having a rod shape. Conductive rod 740 may be constructed from a metallic alloy, for example, a SAE 304 or SAE 316 stainless steel. Rod 740 may be located in proximity to the center of partition 720. Rod 740 may electrically divide each waveguide feeding structure aperture into two substantially equal sections, wherein each section may act as a waveguide feeding structure. Rod 740 may be connected between the upper and lower walls of structures 715a, 715b, 716a and 716b. In some embodiments, rod 740 may be inside the energy application zone. In some embodiments, rod 740 may be outside the energy application zone but in proximity thereto. RF energy may be emitted to each section from a port 735 in radiating element 730. The distance between the ports may be equal to half of a wavelength corresponding to the central frequency in the working band.

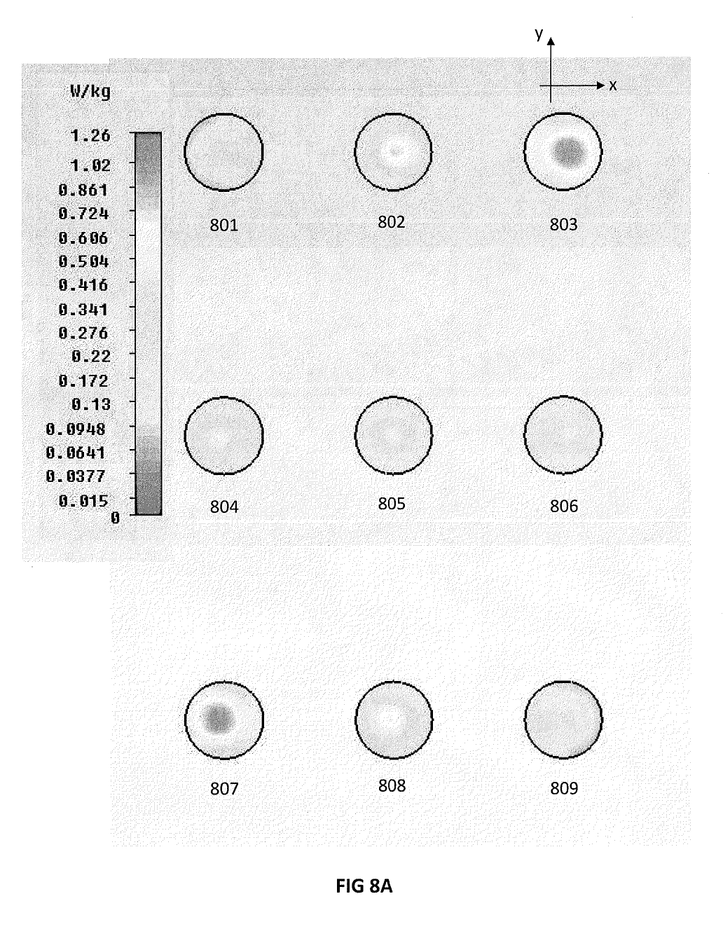

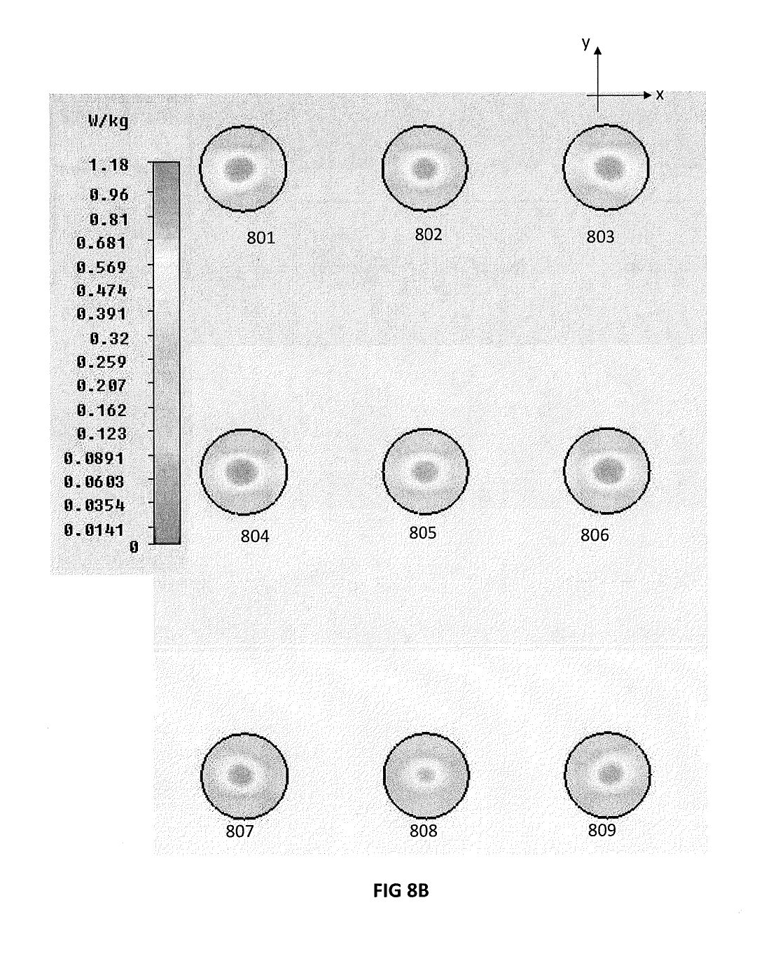

The influence of conductive rods 740 in cavity 710 was simulated using computer simulation software CST Microwave Studio®. Exemplary results of such simulations are shown in FIGS. 8A and 8B. Heating experiments in the top level of oven 700 were simulated. In the simulation, RF energy at 800-1000 MHz was applied when nine 200 ml water cups 801-809 were modeled as being placed in the top energy application zone 725 zone of cavity 710. The results of the simulations are presented in FIGS. 8A and 8B as EM field intensity maps in W/Kg developed in the water cups. In particular, FIG. 8A presents simulation results of RF energy application to zone 725, from radiating elements 730 without the assembly of conductive elements 740 in waveguide feeding structures 715. The intensity bar on the left side of FIG. 8A shows that high field intensities were observed in the upper right (803) and the lower left (807) water cups, indicating inhomogeneous RF energy distribution in the energy application zone. FIG. 8B presents simulated field intensities using the same apparatus except for including conductive elements 740, as illustrated in FIGS. 7A-7D. FIG. 8B shows improved homogeneity in RF energy distribution in the energy application zone, compared to FIG. 8A. It suggests that the RF energy delivered to each of the nine water cups 801-809 was more evenly distributed between all the cups, regardless of their position in the energy application zone. The results shown in FIGS. 8A and 8B may indicate that rods 740 may improve heating uniformity across energy application zone 725.

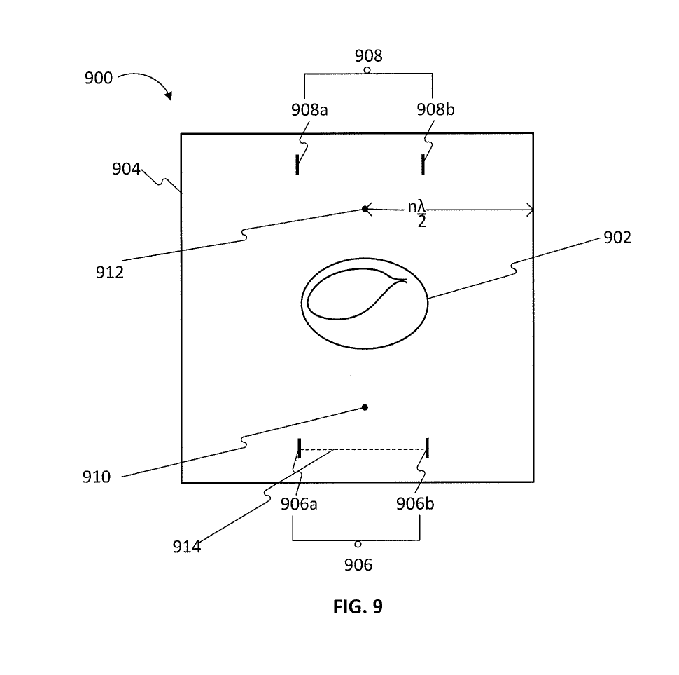

FIG. 9 is a diagrammatic representation of an apparatus 900 for applying RF energy to an object 902 in a cavity 904, according to some embodiments. Apparatus 900 may include a plurality of pairs (e.g., pair 906 and pair 908) of radiating ports. An element having two radiating ports may be referred to a dual-port radiating element. While two pairs are shown, the plurality may also include a larger number of pairs, for example, 3, 4, and 8, etc. Pair 906 includes radiating ports 906a and 906b and pair 908 includes radiating ports 908a and 908b. It is noted that one or more of the pairs may be included in a triplet of ports, for example, as illustrated in FIG. 4C. Radiating ports belonging to the same radiating element may be configured to emit RF radiation into the cavity coherently with each other. Coherency between the ports may be achieved, for example, by feeding the two ports from a common feed (e.g., from a single RF source). In another example, coherency may be achieved by feeding the ports from different but synchronized feeds. For example, the feeds may be fed by synchronized RF sources. The term synchronized may be used for any arrangement that ensures that when one source operates at a given frequency, the other operates also at the same given frequency.

Apparatus 900 may further include a plurality of electrically conductive elements 910, 912. Each electrically conductive element may be floating, partially shorted (e.g., at one end thereof) or completely shorted (e.g., at two ends thereof). In some embodiments, all the conductive elements are floating. In some other embodiments, all the electrically conductive elements are partially shorted. In yet some other embodiments, all the electrically conductive elements are completely shorted. Shorting may be accomplished by electrically connecting the electrically conductive element to a wall of cavity 904. Floating may be accomplished by electrically isolating the conductive element from all walls of cavity 904.

Each electrically conductive element may be positioned between two radiating ports constituting a pair. A conductive element may be considered “between” two ports if a triangle defined by the tops, bottoms, or any other set of selected points of the two ports and the conductive element define an acute-angled triangle. In some embodiments, the acute-angled triangle is isosceles, and the distances between the conductive element and each of the ports are substantially equal. The conducting elements may electrically divide the cavity into sections. Each section may have a width that is at least as large as a half-wavelength of the radiation emitted via the radiating element. If multiple frequencies are used, the wavelength may correspond to the lowest frequency among the frequencies used.

In some embodiments of the invention, electrically conductive elements 910 and 912 are arranged such that RF radiation emitted through the plurality of pairs of radiating ports 906 and 908 concentrates closer to the center of cavity 904 than in the absence of the electrically conductive elements. In some embodiments, this concentration effect may be accomplished when cavity 904 is empty. Additionally, or alternatively, the concentration effect may be accomplished when object 902 is in the cavity.

In some embodiments, a line 914 connecting radiating ports 906a and 906b may be closer to electrically conductive element 910 (positioned between radiating ports 906a and 906b) than to the center of cavity 904 (where object 902 is drawn). For example, the line may be closer to the electrically conductive element than to the cavity center by a factor of at least 2, optionally, by a factor of between 8 and 12, such as 10. The conductive element and the center of the cavity may be on the same side of line 914, as illustrated in the case of line 914 and conductive element 910. In some embodiments, the distance between line 914 and radiating element 910 may be smaller than a half-wavelength of the radiation transmitted or received through radiating ports 906a and 906b. For example, apparatus 900 may include one or more sources (e.g., sources 112 of FIG. 5A or 5B) configured to supply RF energy to ports 906a and 908b at a range of frequencies. The range of frequencies may have a central frequency, corresponding to a central wavelength. The central wavelength may be a wavelength in vacuum of an electromagnetic wave oscillating at the central frequency. For example, the range of frequencies may be from 800 MHz to 1200 MHz, and accordingly the central frequency is 1000 MHz, and the corresponding central wavelength is 30 cm. In some embodiments, the distance between line 914 and conductive element 906 is shorter than half the central wavelength, e.g., shorter than 15 cm in the above example. In some embodiments, the distance may be shorter than the central wavelength by a factor of between 8 and 12, e.g., 10.

In some embodiments, different pairs of radiating ports (possibly all of them) may operate non-coherently with each other. For example, when one transmits at a first frequency, the other transmits at a second frequency different from the first. In another example, a pair of radiating elements may only receive transmissions from another pair and is not connected to an RF source, in which case the two pairs operate non-coherently with one another.

In some embodiments, different pairs or radiating ports (possibly all of them) may operate coherently with each other. For example, when one transmits at a first frequency, the other transmits at the same first frequency. In some embodiments, a phase difference between coherent transmissions by two or more pairs of radiating ports may exist. In some embodiments, the phase difference may be controlled, e.g., by controller 150, shown in FIG. 5B. Additionally or alternatively, different pairs of radiating ports may be fed from different RF sources, similarly to the arrangement shown in FIG. 5A. In some embodiments, the different RF sources may be synchronized.

It will be apparent to those skilled in the art from consideration of the specification and practice of the present disclosure that various modifications and variations may be made to the disclosed systems and methods without departing from the scope of the claims. Thus, it is intended that the specification and examples be considered as exemplary only, with a true scope of the present disclosure being indicated by the following claims and their equivalents.

1. An apparatus for applying RF energy to an object in a cavity, the apparatus comprising:
a plurality of pairs of radiating ports, each pair comprising two radiating ports configured to emit RF radiation into the cavity coherently with each other; and
a plurality of electrically conductive elements, each positioned between two radiating ports constituting a pair of radiating ports,
wherein
the electrically conductive elements are arranged such that RF radiation emitted by the plurality of pairs of radiating ports concentrates closer to the center of the cavity than in the absence of the electrically conductive elements.

2. An apparatus according to claim 1, wherein a line connecting two radiating ports constituting a pair of radiating ports is closer to the electrically conductive element positioned between the two radiating ports than to the center of the cavity by a factor of at least 2.

3. An apparatus according to claim 1, further comprising one or more RF sources configured to supply RF energy to at least two of the radiating ports at a range of frequencies having a central frequency, wherein a distance between the line connecting two radiating ports constituting a pair of radiating ports and the electrically conductive element positioned between the two radiating ports is shorter than half a wavelength of an electromagnetic wave having a frequency equal to the central frequency.

4. An apparatus according to claim 1, wherein an electrically conductive element and the center of the cavity are on the same side of a line connecting two radiating ports, which together constitute a pair of radiating ports.

5. An apparatus according to claim 1, wherein at least one of the pairs of radiating ports include two radiating ports fed from a single feed.

6. An apparatus according to claim 1, wherein at least one of the pairs of radiating ports include two radiating ports, each fed from a different RF source, and the RF sources are synchronized.

7. An apparatus according to claim 1, wherein at least two pairs of radiating ports are configured to emit RF radiation simultaneously at the same frequency.

8. An apparatus according to claim 1, wherein two pairs of radiating ports are configured to emit RF radiation simultaneously at the same frequency with a phase difference.

9. An apparatus according to claim 1, further comprising a first RF source configured to feed a first pair of radiating ports and a second RF source configured to feed a second pair of radiating ports.

10. The apparatus of claim 9, wherein the first and second RF sources are configured to emit RF radiation simultaneously at the same frequency.

11. An apparatus according to claim 1, wherein at least one of the conductive elements is shorted at both ends.

12. An apparatus according to claim 1, wherein at least one of the conductive elements is shorted only at one end.

13. An apparatus for applying RF energy to an object in an energy application zone, the apparatus comprising:
a waveguide feeding structure including an aperture opening to the energy application zone;
an electrically conductive element configured to electrically divide the aperture into two sections; and
two radiating ports each located within one of the two sections of the waveguide feeding structure and configured to emit RF radiation to the energy application zone.

14. An apparatus according to claim 13, wherein the electrically conductive element is located within the waveguide feeding structure.

15. An apparatus according to claim 13, wherein the electrically conductive element is located between the waveguide feeding structure and the energy application zone.

16. An apparatus according to claim 13, wherein the waveguide feeding structure aperture is electrically divided by the electrically conductive element to substantially equal sections.

17. An apparatus according to claim 13, wherein the electrically conductive element is in electrical contact with two walls defining the energy application zone.

18. An apparatus according to claim 13, wherein
a first radiating element having two radiating ports is adjacent to a first wall of the energy application zone,
and a second radiating element having two radiating ports is adjacent to a second wall of the energy application zone opposite to the first wall.

19. An apparatus according to claim 13, comprising two or more radiating elements that emit the RF radiation non-coherently.

20. An apparatus according to claim 13, comprising one or more radiating elements and one or more electrically conductive elements, wherein each of the electrically conductive elements is located in proximity to one of the radiating elements.

21. An apparatus according to claim 13, wherein the electrically conductive element is located along a line connecting the two radiating ports of each radiating element.

22. An apparatus according to claim 13, wherein a distance between the electrically conductive element and each of the radiating ports is substantially the same.

23. An apparatus according to claim 13, wherein the energy application zone is located within a cavity.

24. An apparatus according to claim 19, wherein the radiating elements are configured to apply RF energy to the energy application zone at a plurality of MSEs.

25. An apparatus according to claim 13, further comprising a controller configured to control RF energy application.

26. The apparatus of claim 25, wherein the controller is configured to control the RF energy application based on EM feedback received from the energy application zone.

27. An apparatus for applying RF energy to an object, comprising:
a rectangular cavity, having an opening for a door; a back wall facing the opening; a top wall; a bottom wall; and a first and a second opposing sidewalls;
a first conductive element electrically connected to the top and bottom walls and in proximity to the first opposing sidewall;
a second conductive element electrically connected to the top and bottom walls and in proximity to the second opposing sidewall;
a first radiating element having two radiating ports positioned at substantially equal distances from the first conductive element and configured to emit RF radiation to the rectangular cavity; and
a second radiating element having two radiating ports positioned at substantially equal distances from the second conductive element and configured to emit RF radiation to the cavity.

28. An apparatus according to claim 27, wherein the first radiating element is configured to receive a portion of the RF radiation emitted by the second radiating element and the second radiating element is configured to receive a portion of the RF radiation emitted by the first radiating element.

29. An apparatus according to claim 27, wherein a distance between the first conductive element and the first radiating element is such that the first conductive element is electrically isolated from the first radiating element while affecting the propagation pattern of RF radiation emitted from the first radiating element.

30. An apparatus according to claim 27, wherein the radiating elements emit the RF radiation non-coherently.

31. An apparatus according to claim 27, wherein the radiating elements emit the RF radiation coherently.

32. A method of making an apparatus for applying RF energy to an energy application zone via at least two radiating elements, the method comprising:
obtaining a cavity comprising at least one waveguide feeding structure configured to supply propagating RF wave to the energy application zone; and
installing one or more conductive elements in the cavity, such that an aperture of each of the at least one waveguide feeding structure is electrically divided into at least two sections.
